(19) United States
(12) Patent Application Publication
(10) Pub. No.: US 2010/0033701 A1
(43) Pub. Date: Feb. 11, 2010

(54) Superlens and lithography systems and methods using same

(76) Inventors: Hyesog Lee, Buena Park, CA (US); Massimo A. Sivilotti, Sierra Madre, CA (US); Ravi K. Verma, Pasadena, CA (US)

Correspondence Address: Attn: Kevin Dinniene;Tanner Researach, Inc., 825 South Myrtle Avenu, Monrovia, CA, 91016-3424, US

(21) Appl. No.: 12/228,113

(22) Filed: Aug. 8, 2008

(51) Int. Cl. G03B 27/54; G03B 27/32

(52) U.S. Cl. 355/67; 355/77

(57) ABSTRACT

A superlens that includes, in one example embodiment, a positive-index material adjacent to a negative-index material, wherein the negative-index material includes aluminum. In a more specific embodiment, the positive-index material includes a dielectric layer, such as Poly(Methyl MethAcrylate) (PMMA), which is less than 50 nanometers thick. The negative-index material includes a smoothed aluminum layer less than 50 nanometers thick. The aluminum layer is disposed on the dielectric layer or vice versa, forming a superlens comprising the aluminum layer and the dielectric layer. In another embodiment, the superlens further includes plural aluminum layers separated by one or more layers of positive-index material. A mask is adjacent to the positive-index material. The mask may include one or more features that extend into a transparent substrate. The mask is positioned so that the positive-index material separates the mask from the smoothed aluminum layer. In an illustrative embodiment, the superlens is adapted for use with thermal lithography using nanoparticles.

### BACKGROUND OF THE INVENTION

1. Field of Invention

This invention relates to plasmonic devices. Specifically, the present invention relates to imaging devices, systems, and methods that use electromagnetic energy and plasmons.

2. Description of the Related Art

Plasmonic superlenses may be employed in various demanding applications, including nanolithography for fabricating high-density integrated circuits and extremely small electromechanical devices. Such applications demand cost-effective superlenses and accompanying lithography methods that can reliably be used to create nanometer-scale features.

For the purposes of the present discussion, nanolithography may be any method that uses an imaging system or device to create physical features or things that are characterized by one or more dimensions less than approximately 500 nanometers. A feature or thing with dimensions less than approximately 500 nanometers is called a nanoscale feature. An imaging system or device may be any system or device capable of projecting or otherwise forming an image or projection of an image. Hence, a nanolithography system may be an imaging system.

A superlens may be any lens capable of imaging features smaller than the diffraction limit associated with electromagnetic energy applied to the lens. A lens may be any device for affecting the propagation of energy, such as electromagnetic energy.

Conventionally, silver superlenses may be employed for nanolithography. One such superlens uses a thin silver layer adjacent to a dielectric layer, as taught, for example, in a paper entitled “Sub-Diffraction-Limited Optical Imaging with a Silver Superlens,” by Hyesog Lee, Cheng Sun, Nicholas Fang, and Xiang Zhang, and published in Science, Vol. 308, Apr. 22, 2005, pages 534-537. Unfortunately, such silver superlenses typically work with relatively large wavelengths of electromagnetic energy only, such as 365 nanometer-wavelengths. The imaging of even smaller features may require use of wavelengths smaller than 365 nanometers. Consequently, use of silver superlenses to image extremely small features, smaller than those that have currently been demonstrated, may be problematic. Other nanolithography techniques, such as those using Phase Shift Masks (PSM), double patterning, electron-beam lithography, and so on, are often prohibitively expensive or time consuming.

Hence, a need exists in the art for a superlens usable with small wavelengths of electromagnetic energy and an accompanying reliable, cost-effective, and efficient system and method for using the superlens to create nanoscale features.

### SUMMARY OF THE INVENTION

The need in the art is addressed by a superlens that includes, in one example embodiment, a positive-index material, which may be a material with an index of refraction with a positive real part. A negative-index material, which may be a material with an index of refraction with a negative real part, is adjacent to the positive-index material. In a more specific embodiment, the negative-index material includes aluminum, and the resulting superlens is adapted for use with thermal lithography using nanoparticles.

In another embodiment, the positive-index material includes a dielectric layer that is less than 50 nanometers thick. The dielectric layer includes Poly(Methyl MethAcrylate) (PMMA). The negative-index material includes a smoothed aluminum layer less than 50 nanometers thick. The aluminum layer is disposed on the dielectric layer or vice versa, forming a superlens comprising the aluminum layer and the dielectric layer.

In another embodiment, the superlens further includes plural aluminum layers separated by one or more layers of positive-index material. A mask is adjacent to a first layer of the positive-index material. One or more features of the mask extend into a substantially transparent substrate and/or into the first layer of the positive-index material. The mask is disposed on or in the first positive-index layer so that the positive-index material separates the mask from a first smoothed aluminum layer.

In an illustrative embodiment, the superlens is employed in a nanolithography system, which further includes a photosensitive layer, such as a photoresist layer. The photoresist layer is positioned in proximity to the negative-index material, leaving a space less than 50 nanometers between the photoresist layer and the negative-index material. In the illustrative embodiment, the space is filled with an immersion material, such as purified water, which is characterized by an index of refraction with a real part greater than 1. Layers formed by the negative-index material, positive-index material, and photoresist are smoothed or chemically mechanically polished to reduce or minimize surface roughness. A source of electromagnetic energy is positioned on a side of the nanolithography system closest to the positive-index material. The source of electromagnetic energy is adapted to yield electromagnetic energy with a center frequency corresponding to a wavelength of approximately 193 nanometers. The photoresist layer may be a thermal photoresist layer that includes nanoparticles adapted to resonate with the electromagnetic energy, thereby heating the nanoparticles in a pattern representative of the mask.

The novel design of certain embodiments discussed herein is facilitated by use of aluminum for the negative-index layer; use of an immersion layer between the aluminum and photoresist; use of photoresist material with resonant nanoparticles; and in one embodiment, use of multiple layers of aluminum separated by positive-index materials with different indices of refraction. Use of aluminum enables imaging of smaller features than currently obtainable via use of silver. The aluminum superlens may be used with 193-nanometer-wavelength electromagnetic energy to image features of a mask that are smaller than 100 nanometers at high resolutions, which is typically beyond conventional diffraction-limited resolutions. Furthermore, use of aluminum may result in improved performance over that of other metals, such as silver, when used in non-contact lithography applications, wherein the aluminum layer does not contact the photoresist layer. Use of multiple negative-index layers as discussed herein may further improve resolution. In addition, an immersion layer between the superlens and the photoresist may protect the aluminum layer and may further improve resolution obtainable via certain embodiments, as discussed more fully below.

Furthermore, in certain embodiments discussed herein, the mask, which includes patterns to be imaged on photoresist, is protected by one or more layers and does not contact the photoresist. In embodiments lacking an immersion layer, wherein the negative-index layer contacts the photoresist, the negative-index layer may be readily replaced or re-polished in the event of damage or wear.

### BRIEF DESCRIPTION OF THE DRAWINGS

FIG. 1 is a diagram of a first single-superlens nanolithography system according to a first embodiment for performing immersion lithography.

FIG. 2 is a partially exploded perspective view of the nanolithography system of FIG. 1.

FIG. 3 is a diagram of a second single-superlens nanolithography system according to a second embodiment for performing contact lithography.

FIG. 4 is a diagram of a multi-superlens nanolithography system according to a third embodiment for performing immersion lithography.

FIG. 5 is a flow diagram of an example method for making a superlens and mask employed in the nanolithography system of FIG. 1.

FIG. 6 is a flow diagram of an example lithography method adapted for use with the nanolithography systems of FIGS. 1-3.

FIG. 7 is process flow diagram illustrating a process for using a thermal superlens nanolithography system to create nanoscale features according to a fourth embodiment.

FIG. 8 is a flow diagram of a method adapted for use with the thermal nanolithography system illustrated in FIG. 7.

### DESCRIPTION OF THE INVENTION

While embodiments are described herein with reference to particular applications, it should be understood that the embodiments are not limited thereto. Those having ordinary skill in the art and access to the teachings provided herein will recognize additional modifications, applications, and embodiments within the scope thereof and additional fields in which the present invention would be of significant utility.

For clarity, various well-known components, such as power sources, mounting systems, assembly line components, and so on, have been omitted from the figures. However, those skilled in the art with access to the present teachings will know which components to implement and how to implement them to meet the needs of a given application. Furthermore, the figures are not necessarily drawn to scale.

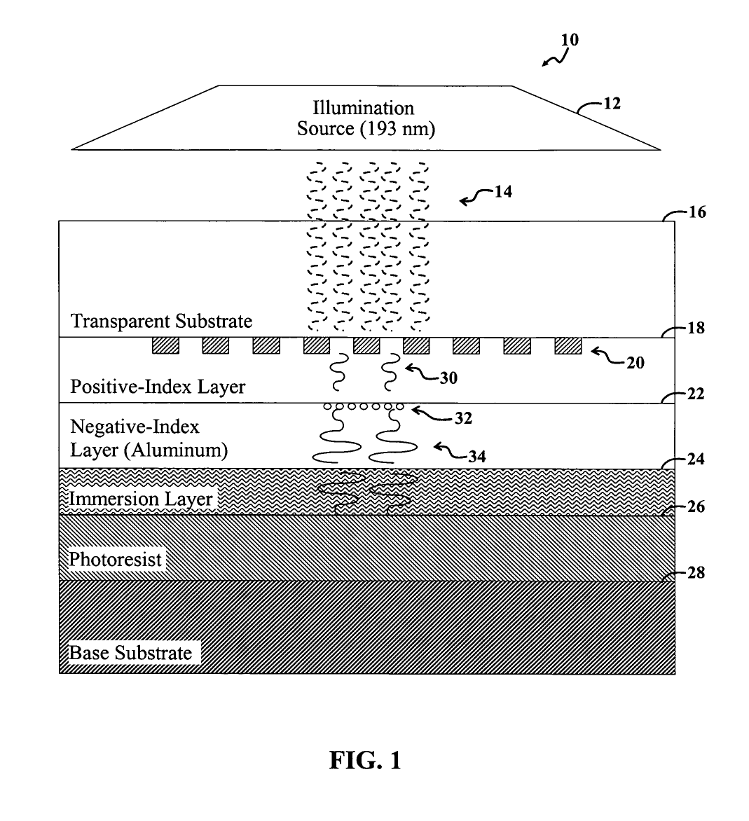

FIG. 1 is a diagram of a nanolithography system 10 according to a first embodiment for performing immersion lithography. For the purposes of the present discussion, a lithography system may be any device or collection of devices adapted to facilitate using an image or projection of an image, such as a mask pattern or other image, to create one or more physical features in or on a material. A nanolithography system may be any lithography system capable of facilitating the creation of nanometer-scale features. A nanometer-scale feature, also called a nanoscale feature, may be any feature or thing with one or more dimensions less than approximately 500 nanometers.

The present nanolithography system 10 is also called a superlens lithography system, or more specifically, a single-superlens nanolithography system, as it employs a single superlens to facilitate nanolithography. A superlens may be any lens or device capable of yielding an image characterized by a resolution less than the diffraction limit associated with electromagnetic energy used to produce the image. Superlenses discussed herein are considered to include both a positive-index layer and a negative-index layer. However, a single negative-index layer alone is sometimes called a superlens.

The diffraction limit associated with electromagnetic energy of wavelength λ limits feature sizes (F) that can be imaged to approximately:

F=k(λ/N_{A}), [1]

where k is a coefficient that encapsulates process-related factors, and N_{A} is the numerical aperture of a lens used for imaging as seen from the surface upon which the image is formed. Generally, the diffraction limit suggests that light cannot be focused smaller than a predetermined fraction of its wavelength. In practice, the fraction is often approximately 0.5.

In the present embodiment, the nanolithography system 10 overcomes the diffraction limit by employing surface plasmon resonance to amplify evanescent waves emanating from an object to be imaged, such as a mask, as discussed more fully below. The nanolithography system 10 includes an illumination source 12 that produces a beam of electromagnetic energy 14 with center frequency corresponding to a wavelength of approximately 193 nanometers. However, other wavelengths of electromagnetic energy may be employed without departing from the scope of the present teachings. The illumination source 12 may be an argon-fluoride excimer laser.

The nanolithography system 10 further includes a transparent substrate 16 that is substantially transparent to the electromagnetic energy 14. The transparent substrate 16 is adjacent to a positive-index layer 18. An example opaque mask 20 is formed in the positive-index layer 18, such as via electron-beam lithography, as discussed more fully below. Typically, the mask 20 and the positive-index layer 18 are deposited on the transparent substrate 16. The negative-index layer 22 is then deposited on the positive-index layer 18. Alternatively, the transparent substrate 16 may be vapor deposited on the positive-index dielectric layer 18 and mask 20 embedded therein at an interface between the transparent substrate 16 and the positive-index layer 18. The positive-index layer 18 is adjacent to a negative-index layer 22, which is disposed on a side of the positive-index layer 18 opposite the transparent substrate 16. An immersion layer 24 separates the negative-index layer 22 from a photosensitive layer 26, which is a photoresist layer 26 in the present specific embodiment. The photoresist layer 26 is disposed on a base substrate 28.

For the purposes of the present discussion, a positive-index material may be any material with an index of refraction, also called refraction index, characterized by a positive real part. The positive-index dielectric layer 18 may be made from any suitable positive-index material. In the present specific embodiment, the positive-index layer 18 is a dielectric material that is less than 50 nanometers thick and is substantially transparent to the electromagnetic energy 14. A dielectric may be any non-metal insulator or other material that is substantially not electrically conductive at voltages less than the breakdown voltage of the dielectric. An example positive-index dielectric material usable to form the positive-index dielectric layer 18 is PMMA. However, the exact type of positive-index material is application specific and may include other positive-index materials, such as SiO2, or combinations of different dielectric materials. For example, the positive-index material may be a mix of PMMA, Parylene, and polycarbonate, where the percentage of each material in the mix is adjusted to achieve a desired refractive index. In the present specific embodiment, the real part of the electric permittivity of the positive-index material 18 is tuned to be approximately equal to the absolute value of the real part of the electric permittivity of the negative-index layer 22. This helps to impedance match the positive-index layer 18 with the negative-index layer 22 to enhance excitation of surface plasmons 32. Note that both the real and imaginary parts of the refractive index of the negative-index layer 22 contribute to the real part of the electric permittivity, which is closely matched (in terms of absolute value) with that of the positive-index layer 18. The real part of the refractive index of the so-called negative-index layer 22 is positive in the present embodiment. For various metals, such as aluminum, the electric permittivity is negative (not the refractive index), although, in the near field, the refractive index may behave as though it is negative.

A negative-index material may be any material with a refractive index characterized by a negative real part. The negative-index layer 12 may comprise any suitable negative-index material. In the present specific embodiment, the negative-index layer 22 is an aluminum layer that is less than approximately 50 nanometers thick. The absolute value of the real part of the electric permittivity of the aluminum layer 22 is approximately equal to the real part of the electric permittivity of the positive-index material 18 for the electromagnetic energy 14. The negative-index layer 22 is sufficiently thin to be substantially transparent to evanescent waves 30 from the mask 20, which result from application of the electromagnetic energy 14. Evanescent waves 30 represent decaying standing waves emanating from the mask 20. The evanescent waves 30 are generated by interaction of the electromagnetic energy 14 with the mask 20. The negative-index layer 22 is dimensioned to result in surface plasmon resonance sufficient to amplify the evanescent waves 30, as discussed more fully below.

The mask 20 exhibits a desired pattern to be imaged on the photoresist 26. The mask 20 is made from a material that is substantially opaque to the electromagnetic energy. Generally, the mask material is chosen to have a relatively low skin depth of less than approximately 15 nanometers, although materials with larger skin depths may be employed. The mask 20 may be made from Tungsten (W) that is approximately 50 nanometers thick. For the purposes of the present discussion, a mask may be any device or thing that selectively blocks a desired wavelength of electromagnetic energy in a desired pattern or shape.

For the purposes of the present discussion, an immersion material may be any material used to immerse or separate one material or thing from another material or thing. In the present specific embodiment, the immersion layer 24 is substantially transparent to the electromagnetic energy 14. The immersion layer 24 is less than approximately 50 nanometers thick and has a refractive index greater than 1. An example material usable for the immersion layer 24 is purified de-gassed water. Note that the immersion layer 24 may be omitted or replaced with air, vacuum, or other material without departing from the scope of the present teachings.

The effective wavelength of far-field electromagnetic energy passing through the immersion layer 24 is reduced by a factor approximately equivalent to the refractive index of the immersion layer 24. This may further increase the resolution of an image of the mask 20 transferred to the photoresist layer 26. Far-field electromagnetic energy may represent the component of electromagnetic energy not including an evanescent component.

The photoresist layer 26 may be made from any suitable photosensitive material. A photosensitive material or layer may be any material or layer that changes properties, such as mechanical, chemical, electrical, or other properties, in response to electromagnetic energy of a predetermined wavelength or intensity. In the present specific embodiment, photoresist layer 26 changes solubility in response to exposure to the electromagnetic energy 14. A suitable photoresist material is EPIC™ 193 nm PR from Rohm and Haas Company, which is made by Japan Synthetic Rubber Microelectronics (JSR Micro). EPIC™ 193 nm PR is a negative photoresist material, which hardens or becomes substantially insoluble or less soluble to a particular solvent upon exposure to the electromagnetic energy 14.

In the present specific embodiment, each of the layers 16-28 are smoothed layers. A smoothed layer may be any layer that has been treated or formed to minimize or reduce surface roughness. For example, a specially polished spin coated or vapor deposited material is considered to be a smoothed layer, since such processes, including polishing, act to reduce or minimize surface imperfections in the material. The layers 16-28 are smoothed to reduce the surface root mean square modulation to below approximately 1 nanometer.

The exact thickness of each of the various layers 16-28 are application specific and may be chosen based on the wavelength of the electromagnetic energy 14, the dimensions of the mask 20 to be imaged, the desired resolution of an image of the mask 20 transferred to the photoresist layer 26, and so on. Generally, the thickness of each layer 16-28 is tuned to ensure adequate transmission of evanescent waves from mask pattern to the photoresist layer 26. Layer thickness determinations may be made via software simulation, trial and error, i.e., testing, and/or other suitable techniques, which may be application specific. For example, in certain embodiments, the thickness of negative-index layer 22 may be chosen to correspond to the peak transmissivity of transverse magnetic waves of the electromagnetic energy 14. In other embodiments, the thickness of the negative-index layer 22 is chosen to be the thinnest possible layer that still yields adequate transmission and amplification of evanescent waves.

In the present specific embodiment, the positive-index layer 18 is approximately 20 nanometers thick, and the negative-index layer 22 is approximately 20 nanometers thick. The immersion layer 24 is also approximately 20 nanometers thick. Hence, the negative-index layer 22 is positioned in the near field from the photoresist layer 26. The near field corresponds to a distance less than approximately one wavelength of the electromagnetic energy 14 from the surface of the photoresist layer 26.

Various layers 18, 22, 24 may be sized so that the net optical thickness between the mask 20 and the photoresist layer 26 is zero. In this case, the dipole strength of the mask 20 is reproduced on the incident surface of the photoresist layer 26. This facilitates nanolithography beyond the diffraction limit.

In operation, the illumination source 12 is activated, which transmits the electromagnetic energy 14 through the transparent substrate 16 toward the mask 20. Evanescent waves 30 result from the interaction of the electromagnetic energy 14 and the mask 20. The evanescent waves 30 extend through the positive-index layer 18. Note that for clarity, additional waves, such as far field waves passing through the mask 20 are not shown.

In the present embodiment, the illumination source 12 is set to illuminate for approximately 60 seconds, which results in a 60-second photoresist exposure time. Note however, that the exact exposure time is application specific and may be longer or shorter than 60 seconds. Furthermore, the electromagnetic energy 14 represents collimated polarized plane waves with a center frequency corresponding to a wavelength of approximately 193 nanometers, although electromagnetic energy with other properties may be employed.

The evanescent waves 30 decay in the positive-index material 18 until reaching the negative-index layer 22. The evanescent waves 30 impinging on the negative-index layer 22 result in plasmons 32 at the incident surface of the negative-index material 22. Plasmons are collective oscillations of electrons or other electrical charges. Plasmons may behave as waves with wavelengths shorter than the wavelength of the impinging electromagnetic energy 14.

Coupling between the surface plasmons 32 and the incident evanescent waves 30 result in surface plasmon resonance. To enhance surface plasmon resonance and resulting superlensing, the negative-index layer 22 is dimensioned so that surface plasmons, also called surface current oscillations, match or resonate with the evanescent waves 30 from the mask 20, resulting in amplified evanescent waves 34. The amplified evanescent waves 34 are thought to increase in amplitude as they transit the thin negative-index layer 22. The increased amplitude of the evanescent waves 34 correspond to increased intensity of the evanescent waves 34. The evanescent waves 34 begin to decay in the immersion layer 24 upon exit from the negative-index layer 22.

The resulting evanescent waves 34 impinging on the photoresist layer 26 carry sub-wavelength information about the mask pattern 20. Consequently, the conventional diffraction limit of equation (1) is inapplicable, i.e., not limiting, and higher imaging resolution may be obtained. Use of plasmons and evanescent waves to facilitate lithography is also discussed in U.S. Patent Application Publication No. US 2007/0159617, entitled PHOTOLITHOGRAPHIC SYSTEMS AND METHODS FOR PRODUCING SUB-DIFFRACTION-LIMITED FEATURES, the teachings of which are hereby incorporated by reference herein.

The resulting image of the mask 20 formed by the pattern of evanescent waves 34 impinging on the photoresist 26 represents a high resolution image of the mask 20, which is called a non-diffraction-limited image. The evanescent waves denature or otherwise change the solubility of the photoresist 26 in a pattern representative of the mask pattern 20. The photoresist layer 26 may then be exposed to a solvent to dissolve or wash away more soluble portions of the photoresist layer 26, thereby resulting in photoresist that is patterned in accordance with the mask pattern 20.

Alternatively, the photoresist layer 26 includes a cross-linking agent and further includes nanoparticles, as discussed more fully below. The resulting photoresist layer 26 acts as a so-called thermal photoresist layer, the solubility of which changes in response to heating. In this alternative embodiment, the nanoparticles embedded in the photoresist layer 26 are adapted to resonate with electromagnetic energy 34. This results in heating of the nanoparticles in a pattern representative of the mask 20. The heated nanoparticles decrease the solubility of the surrounding photoresist, enabling the remaining photoresist to be removed, leaving a pattern of features in the photoresist, wherein the pattern of features is representative of the mask 20. In this case, the photoresist material 26 is chosen so that the photoresist material 26 is activated for thermal lithography by the electromagnetic energy 34. While in this alternative implementation, the photoresist layer 26 is called photoresist, it may alternatively be called thermal resist. For the purposes of the present discussion, thermal resist may be any material that changes solubility in response to a predetermined temperature or application of a predetermined amount of thermal energy or heat.

Note that various layers of the nanolithography system 10 may be omitted or replaced with other types of layers with similar or different thicknesses without departing from the scope of the present teachings. For example, the transparent substrate 16 may be omitted in certain implementations. Furthermore, the immersion layer 24 may be omitted in contact lithography applications. In addition, the photoresist layer 26 may be replaced with film or other photosensitive or thermal-sensitive material or device. Furthermore, the mask 20 may be recessed in the transparent substrate instead of in the positive-index layer 18, as discussed more fully below.

Note that the superlens formed by the positive-index layer 18 coupled to the negative-index aluminum layer 22 may be used separately from the lithography system 10 without departing from the scope of the present teachings. Various fields and applications, not just lithography, may benefit from use of the novel superlens 18, 22. For example, machine vision systems, high-resolution microscopes, and readers and writers for high capacity data-storage devices may use the novel aluminum-based superlens 18, 22. Such applications are considered to be within the scope and spirit of the present teachings.

Generally improved imaging resolutions may be obtained by employing thinner smoother layers that are tuned in accordance with the wavelength of the electromagnetic energy used.

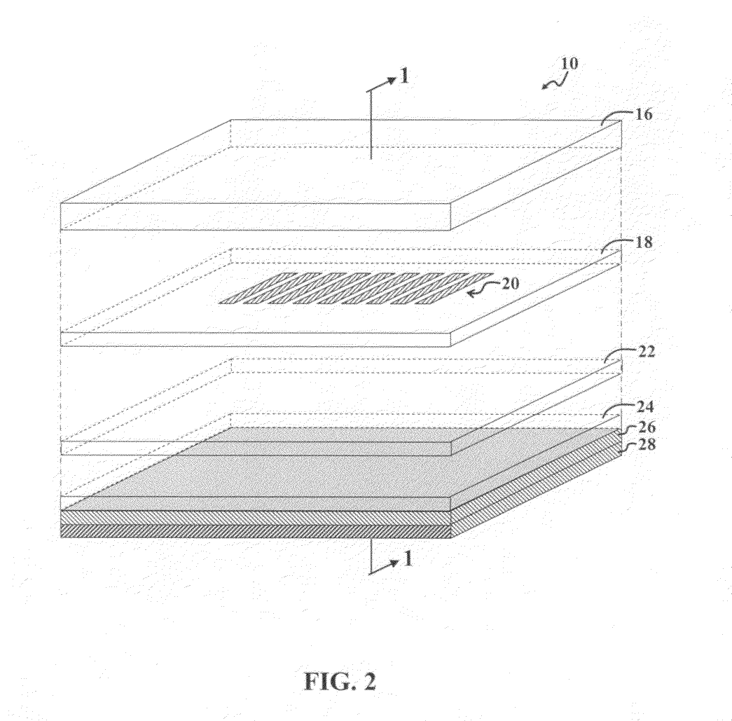

FIG. 2 is a partially exploded perspective view of the nanolithography system 10 of FIG. 1. The transparent substrate 16 acts to protect the mask 20 disposed on or in the positive-index material 18.

In the present specific embodiment, the mask 20 is shown as a simple grating 20. However, the mask 20 may be replaced with a circuit design, an electromechanical nanostructure design, etc.

While the various layers 16-28 exhibit substantially square or rectangular cross sections, other shapes are possible. For example, the layers 16-28 may be circular, oval, or another shape. Furthermore, the thickness of a given layer, such as the positive-index layer 18 and/or the negative-index layer 22 may be strategically varied across the surface of the layer to obtain different optical effects and variations in resolution in the resulting image of the mask projected onto the photoresist layer 26. For example, the transparent substrate 16 may exhibit a convex or concave surface adapted to selectively focus incident electromagnetic energy on the mask 20.

Furthermore, while in the present embodiment, the superlens 18, 22 formed by the positive-index layer 18 and the negative-index layer 22 is adapted for use with immersion lithography, the superlens 18, 20 may be used in combination with other techniques, such as double patterning and/or contact lithography without departing from the scope of the present teachings. In addition, while the immersion layer 24 is discussed as being a substantially static fluid or gas, moving fluids, gasses or other interfaces may replace the immersion layer 24.

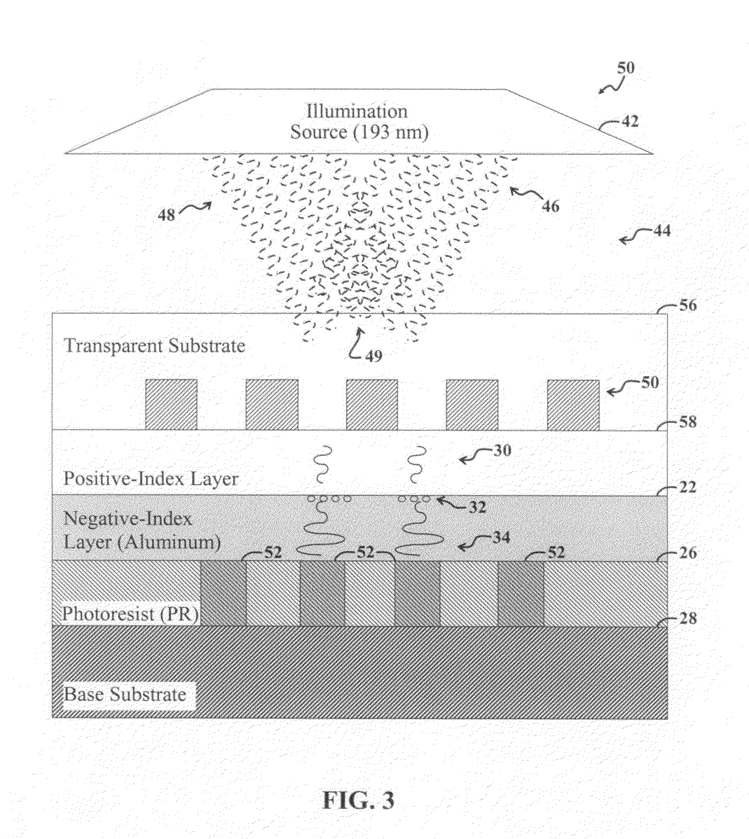

FIG. 3 is a diagram of a single-superlens nanolithography system 40 according to a second embodiment for performing contact lithography. The construction and operation of the second single-superlens lithography system 40 is similar to the construction and operation of the first super-lens lithography system 10 of FIG. 1 with the exception that the immersion layer 24 of FIG. 1 is removed in FIG. 2, and the mask 20 of FIG. 1 is replaced with a thicker mask 50 that extends into a transparent substrate 56 instead of extending into the positive-index layer 58. Furthermore, the illumination source 12 of FIG. 1 is replaced with the alternative illumination source 42, which is adapted to produce multiple selectively angled beams of collimated electromagnetic energy 46, 48. In the present specific embodiment, the beams 46, 48 are angled approximately forty-five degrees so that they intersect, forming an interference pattern 49. The interference pattern 49 represents a coupling of the beams 46, 48. By strategically coupling the beams 46, 48, the effective wavelength of the interference pattern 49 is approximately half that of the electromagnetic energy of the individual beams 46, 48. Use of the interference pattern 49 may enable larger mask features to be used while achieving similar imaging resolutions as would be achieved with a smaller mask features without use of the interference pattern 49. In certain applications, this may alleviate the need to make masks with smaller feature dimensions, which may be harder to make than masks with lager feature dimensions.

While in the present specific embodiment, two angled beams 46, 48 are shown, a different number of angled beams may be employed to selectively create interference patterns without departing from the scope of the present teachings. Furthermore, the beams 26, 48 may be angled other than forty-five degrees.

The nanolithography system 40 is adapted for use with contact lithography, wherein the negative-index layer 22 is adjacent to and contacts the photoresist layer 26. Use of contact lithography effectively brings the amplified evanescent waves closer to the photoresist layer 26 before they decay in an immersion layer. This may enhance the effectiveness by which the evanescent waves change the solubility of the photoresist 26 and may improve resolution in certain applications.

For illustrative purposes, the evanescent waves 34 are shown resulting in hardened or insoluble photoresist sections 52 representative of the spaces between features of the mask 50. When the photoresist layer 26 is subsequently exposed to a desired solvent, the remaining unhardened photoresist dissolves, leaving nanostructures corresponding to the hardened photoresist sections 52. The hardened photoresist sections 52 may be sub-wavelength features, which are features smaller than a wavelength of the electromagnetic energy 14 from the illumination source 12.

Note that conventional contact lithography may involve placing a mask directly on a photoresist layer, such methods may damage the mask after repetitive use. This necessitates periodically constructing a new mask, which may be prohibitive.

In the present embodiment, if the negative-index layer 22 exhibits wear from repeated contact with a photoresist layer, such as the layer 26, the negative-index layer 22 may be simply stripped and re-deposited with a fairly inexpensive deposition process, such as vapor deposition. This process is typically significantly less expensive that creating a new mask. The present embodiment generally obviates the need to replace the mask 50, which is protected by the transparent substrate 16 and adjacent positive-index layer 58.

The mask 50 may be formed on the positive-index layer 58 via various methods, such as via electron-beam lithography. Material used to make the transparent substrate, such as silicon dioxide, may be spin coated or vapor deposited on the resulting mask structures 50. The negative-index layer 22 may be vapor deposited on the opposite side of the positive-index layer 58. Various smoothing steps may be employed to ensure layers with smooth surfaces.

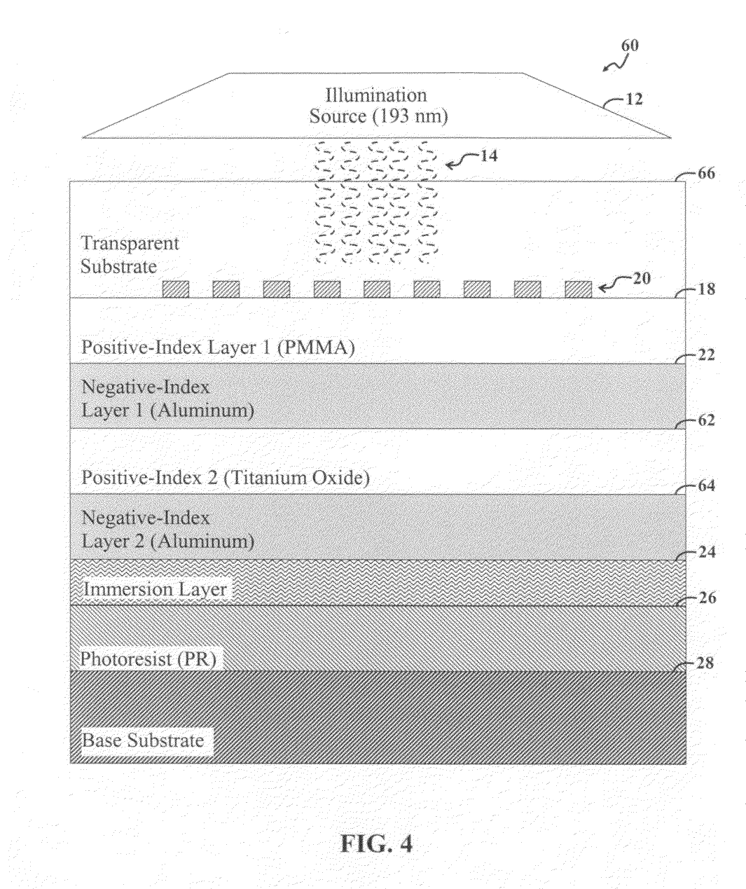

FIG. 4 is a diagram of a multi-superlens nanolithography system 60 according to a third embodiment for performing immersion lithography. The construction and operation of the multi-superlens nanolithography system 60 is similar to the construction and operation of the first single-superlens nanolithography system 10 of FIG. 1 with the exception that an additional superlens 62, 64 comprising a second positive-index layer 62 adjacent to a second negative-index layer 64 is positioned after the first negative-index layer 22 of the first superlens 18, 22. Furthermore, the mask 20 extends into a transparent substrate 66.

Evanescent waves output from the first negative-index layer 22 are slightly attenuated in the second positive-index layer 62 before being amplified again via surface plasmon resonance by the second negative-index layer 64. Use of multiple superlens as shown in FIG. 2 may further enhance resolution obtainable by the nanolithography system 60.

In the present specific embodiment, the second positive-index layer 62 is made from a different material than the first positive-index layer 18. An example material for the second positive-index layer 62 is titanium oxide. Generally the second positive-index layer 62 has a refractive index or dielectric constant with a larger real part than the refractive index or dielectric constant of the first positive-index layer 18, which may be PMMA. Furthermore, the absolute value of the real part of the electric permittivity of the second positive-index material 62 is closer in value to the absolute value of the real part of the electric permittivity of the second negative-index layer 64 than to the real part of the electric permittivity of the first positive-index layer 18. The first negative-index layer 22 and the second negative-index layer 64 are aluminum layers in the present embodiment.

Note that while two superlens, including the first superlens 18, 22 and the second superlens 62, 64, are shown in FIG. 4, more or fewer superlenses may be employed. Furthermore, the photoresist 28 may be thermal resist mixed with nanoparticles adapted to resonate with a desired wavelength of electromagnetic energy.

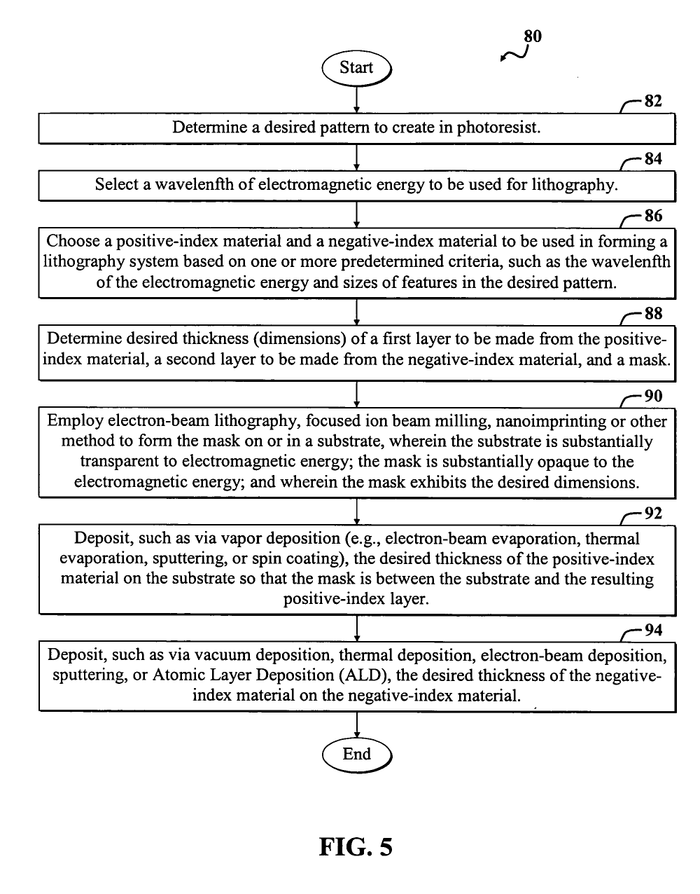

FIG. 5 is a flow diagram of an example method for making a superlens 58, 22 and mask 50 employed in the nanolithography system of FIG. 1. The method 80 includes a first step 82, which includes determining a desired pattern to create in photoresist. The pattern is to be imaged onto a photoresist layer via a mask and an illumination source, as discussed more fully below.

In a second step 84, a wavelength (e.g., 193 nanometers) of electromagnetic energy is chosen for use in with the associated nanolithography system. This wavelength affects the thicknesses of various layers and the types of materials used to form the accompanying nanolithography system. The refractive indices of the materials chosen to form positive-index and negative-index layers may vary based on the wavelength or frequency of electromagnetic energy chosen. The refractive indices are chosen to have real parts with opposite signs and approximately equivalent absolute values. The thicknesses of the layers are chosen to be less than a wavelength of the electromagnetic energy chosen.

A third step 86 includes choosing a positive-index material and a negative-index material to be used in forming the accompanying lithography system based on one or more predetermined criteria. The one or more predetermined criteria may include the wavelength of the electromagnetic energy and sizes of features in the desired pattern.

A fourth step 88 includes determining desired thicknesses and/or other dimensions of a first layer to be made from the positive-index material, a second layer to be made from the negative-index material, and a mask.

A fifth step 90 includes employing electron-beam lithography, focused ion beam milling, nanoimprinting or other suitable method to form the mask on or in a substrate. Note that the exact method used to form the mask is application specific and may include methods not discussed herein, without departing from the scope of the present teachings. The substrate in or on which the mask is formed is substantially transparent to the selected wavelength of the electromagnetic energy. While in the present embodiment, the mask is discussed as being formed on the transparent substrate, alternatively, the mask may be formed first, such as on or in the a positive-index material, and the transparent substrate may be disposed on the mask and/or on the positive-index material on or in which the mask is formed. The mask is substantially opaque to the electromagnetic energy and exhibits the desired dimensions.

A sixth step 92 includes depositing a desired thickness of positive-index material on the transparent substrate and mask so that the mask is between the transparent substrate and the resulting positive-index layer formed from the positive-index material. Possible methods for depositing the positive-index material include, but are not limited to, vapor deposition, electron-beam evaporation, thermal evaporation, sputtering, or spin coating. In the present specific embodiment, the positive-index material is or includes a dielectric, such as PMMA.

A seventh step 94 includes depositing, such as via vacuum deposition, thermal deposition, electron-beam deposition, sputtering, or Atomic Layer Deposition (ALD), the desired thickness of the negative-index material on a side of the positive-index material opposite the mask and transparent substrate. In the present specific embodiment, ALD is employed to form a negative-index layer from the negative-index material, which includes or is made substantially of aluminum.

Note that various steps of the method 80 may be replaced with other steps. In addition, certain steps may be interchanged with other steps, and additional or fewer steps, such as layer-smoothing steps, may be included. For example, the negative-index layer formed in the sixth step 92 may be made on the positive-index layer formed in the fourth step 88 before the mask, which is formed in the fifth step 90, is formed on the positive-index layer. As an additional example, a more general method includes determining a desired pattern to create in photosensitive material; selecting a wavelength of electromagnetic energy to which the photosensitive material is sensitive; creating a mask based on the desired pattern; forming a first layer of positive-index material, wherein the mask is positioned on, in, or in proximity to the first layer of positive-index material; and forming a second layer of negative-index material on the first layer, wherein the second layer is characterized by a thickness and material type according to the wavelength and dimensions of the desired pattern. As another example, steps 86-94 may be repeated for form multiple superlenses, such as employed by the nanolithography system 60 of FIG. 4. Furthermore, additional steps, such as steps involving creation of an immersion layer, photoresist layer, and photoresist substrate may be included.

Another example method includes creating a mask, such as via electron-beam lithography, focused ion beam milling, nanoimprinting, and so on, wherein the mask is opaque to a working wavelength of electromagnetic energy and is chosen to have a skin depth sufficient to yield desired opacity of the mask. Subsequently, a positive-index layer is deposited on the mask, such as via vapor deposition. A planarization step is then used to smooth the positive-index layer to eliminate or substantially flatten uneven surfaces after deposition. Planarization or smoothing may include Chemical Mechanical Polishing (CMP). For spin-coated viscus liquid materials, such as photoresist or spin-on-glass, other known planarization or smoothing methods, such as polishing, may be employed to reduce or eliminate surface irregularities. Subsequently, a negative-index layer, such as aluminum, is deposited on the positive-index layer, such as via vacuum deposition, sputtering, ALD, and so on. ALD may be employed to obtain relatively flat and smooth surfaces lacking substantial surface irregularities or roughness. The positive-index layer and the negative-index layer have a thickness less than approximately 50 nanometers in the present embodiment. The exact thicknesses of the negative-index layer and the positive-index layer are application specific, but may be optimized to obtain the best electric field intensity and contrast depending on the wavelength used and exact materials choices for the layers.

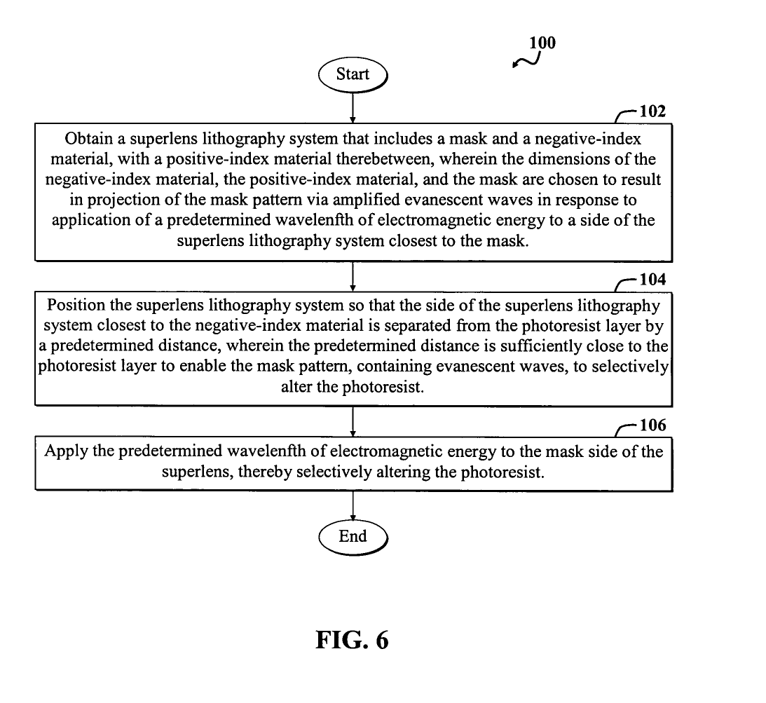

FIG. 6 is a flow diagram of an example lithography method 100 adapted for use with the nanolithography systems of FIGS. 1-3. The method 100 includes a first step 102, which includes obtaining a superlens lithography system having a mask and a negative-index material with a positive-index material therebetween. The dimensions of the negative-index material, the positive-index material, and the mask are chosen to result in projection of the mask pattern, via amplified evanescent waves, in response to application of a predetermined wavelength of electromagnetic energy to a side of the associated superlens lithography system closest to the mask.

A second step 104 includes positioning the superlens lithography system so that the side of the superlens lithography system closest to the negative-index material is separated from the photoresist layer by a predetermined distance. The predetermined distance is sufficiently close to the photoresist layer to enable the transmitted mask pattern, which includes evanescent waves, to selectively alter the photoresist.

A third step 106 includes applying the predetermined wavelength of electromagnetic energy to the mask side of the superlens lithography system, thereby selectively altering the photoresist.

Note that various steps 102-106 of the method 100 may be replaced with other steps. In addition, certain steps may be interchanged with other steps, and additional or fewer steps may be included. For example, a film or other photosensitive layer may be used in place of photoresist without departing from the scope of the present teachings. As another example, an immersion layer, such as purified water may be employed to separate the negative-index material from the photoresist by the predetermined distance, which may be less than approximately 50 nanometers. An example additional step includes selectively removing altered or unaltered photoresist, such as via a photoresist solution, thereby yielding a desired pattern in the photoresist.

An example more specific method includes shining light with a center frequency corresponding to approximately 193 nanometers from the transparent-substrate side of the associated nanolithography system. A sub-wavelength mask structure, such as a mask structure with one or more features with dimensions less than approximately 100 nanometers, will scatter the light and generate evanescent waves. The strength of evanescent field corresponding to the evanescent waves decays along the thickness of a positive-index material before it is enhanced by a negative-index aluminum superlens layer. Through this enhancement process, the original field profile corresponding to an image of the mask structure is reproduced on the exterior surface of the aluminum film corresponding to the negative-index layer. The image is then transferred to a photoresist film, i.e., layer, coated on a separate substrate. The gap or space between the photoresist film and the aluminum layer is less than approximately 50 nanometers and is filled with an immersion material, such as water or other suitable liquid in the present embodiment.

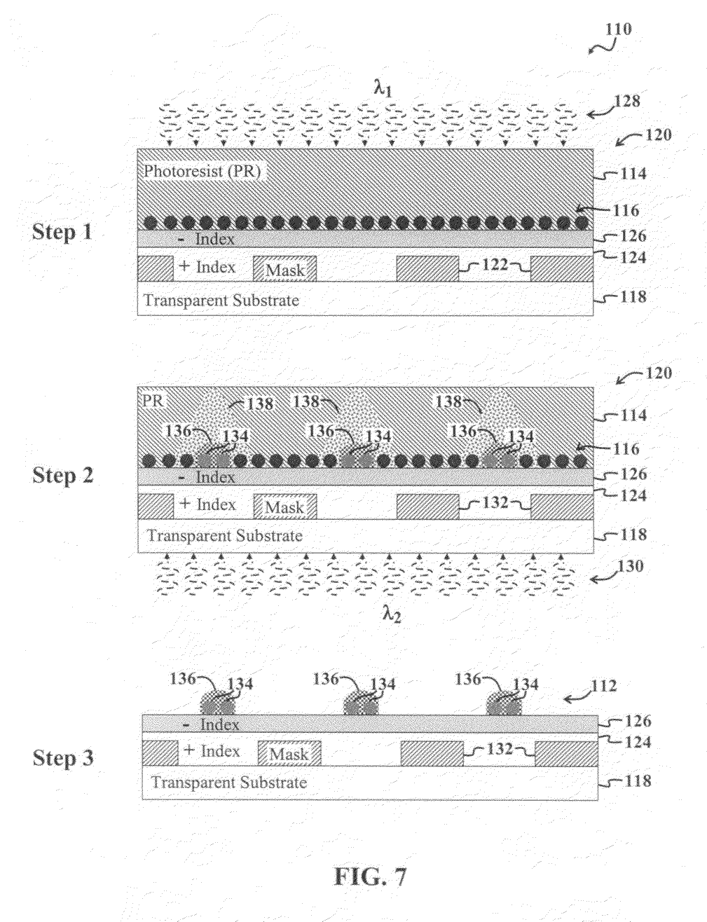

FIG. 7 is process flow diagram illustrating a process 110 for using a thermal superlens nanolithography system 120 to create nanoscale features 112 according to a fourth embodiment. For the purposes of the present discussion, a thermal superlens nanolithography system may be any lithography system that employs a superlens and heat to facilitate forming one or more nanoscale features.

In a first step (step 1), a layer of thermal photoresist 114, which is considered part of the thermal superlens nanolithography system 120, is activated or cured to make the solubility of the photoresist 114 responsive to heat, as discussed more fully below.

The thermal superlens nanolithography system 120 includes a transparent substrate 118, which is adjacent to a mask 122, which is adjacent to a positive-index layer 124, which is adjacent to a negative-index layer 126, such as aluminum. The various layers 114, 118, 124, 126 and mask 122 form the thermal superlens nanolithography system 120, which may be replaced with another type of superlens lithography system without departing from the scope of the present teachings. The thermal superlens nanolithography system 120 further includes a layer of nanoparticles 116, which are dispersed in two dimensions across a surface of the negative-index layer 126 that is opposite the positive-index layer 124. The layer of thermal photoresist 114 is deposited, such as via spin coating, on the layer of nanoparticles 116. The exact method used to apply photoresist to the surface of the negative-index layer 126 and nanoparticles 116 is application specific. Those skilled in the art with access to the present teachings may readily determine another suitable method for applying photoresist without undue experimentation.

In the present specific embodiment, to activate or cure the photoresist 114, the photoresist 114 is exposed to a first wavelength (λ1) of electromagnetic energy 128. In the present specific embodiment, the photoresist 114 is a thermal photoresist that is activated via application of ultraviolet electromagnetic energy (λ1). The exact type of photoresist is application specific and may be changed to meet the needs of a given application. For example, thermal photoresist that does not first require activation by the electromagnetic energy 128 may be employed.

While in the present embodiment, the nanoparticles 16 are dispersed in a thin layer (approximately one nanoparticle deep) of adjacent nanoparticles, other combinations of nanoparticles and photoresist may be employed. For example, nanoparticles may be mixed with the photoresist 114, such that the nanoparticles are distributed in three dimensions in the photoresist 114, without departing from the scope of the present teachings. In such implementations, only nanoparticles that are sufficiently close to the interface between the photoresist 114 and the negative-index layer 126 to resonate with electromagnetic energy 138 emanating from the negative-index layer 126 will sufficiently heat the thermal photoresist 114 to create insoluble patterns.

In a second step (step 2), a second wavelength (λ2) of electromagnetic energy 130 is applied to a side of the transparent substrate 118 opposite the positive-index layer 124. The second wavelength λ2 is chosen to resonate with the nanoparticles 116 or vice versa. For example, if the second wavelength λ2 of electromagnetic energy 130 is chosen to be approximately 193 nanometers, the dimensions, mass, and material properties of each nanoparticle 116 are chosen so that each nanoparticle 116 absorbs energy from evanescent waves of the electromagnetic energy 130, which emanate from the negative-index layer 126 and generally coincide with the electric field pattern 138. The energy absorbed by the nanoparticles 116 results in oscillation and heating of the nanoparticles 116. Note that exact methods for choosing nanoparticle size, mass, and other properties to resonate with a given wavelength of electromagnetic energy are application specific. Those skilled in the art with access to the present teachings may employ one or more well known methods for selecting properties of the nanoparticles 116 to resonate with a given wavelength of electromagnetic energy.

In the present specific embodiment, second wavelength λ2 of electromagnetic energy 130 is patterned via a mask 132 and a superlens formed by the positive-index layer 124 and the negative-index layer 126. Sub-wavelength information about the mask 132 is transferred to the layer of nanoparticles 116 via evanescent waves emanating from the negative-index layer 126.

The applied electromagnetic energy 130 results in the electric field profile 138 within the photoresist 114, which is sufficiently strong to heat certain nanoparticles 134 in the field. Certain nanoparticles 134 exposed to the electromagnetic energy 130 and resulting and field 138 resonate with the evanescent waves, thereby heating the surrounding thermal photoresist 114. The increased temperature hardens photoresist around the heated nanoparticles 134, resulting in relatively insoluble activation areas 136 about the heated nanoparticles 134. Photoresist in the activation area 136 becomes relatively insoluble to solvent that is subsequently used to wash the remaining photoresist 114 from the thermal superlens nanolithography system 120.

A third step (step 3) includes washing soluble unheated portions of the photoresist 114 from the system 120 via a suitable solvent. The exact choice of solvent is application specific and depends on the particular type of photoresist employed. Removal of the soluble portion of the photoresist 114 leaves the nanoscale features 112 on the negative-index layer 126.

With reference to the thermal nanolithography system 120 depicted in step 2 of FIG. 7, in an alternative implementation, the photoresist 114 is first deposited, such as via spin coating on a substrate (not shown), which would be on a side of the photoresist 114 opposite the negative-index layer 126. The photoresist 114 may be mixed with the nanoparticles 116. Alternatively, the nanoparticles may be deposited on the substrate before the photoresist 114 is spun on the substrate. Alternatively, the nanoparticles may be embedded in a surface of the photoresist 114 opposite the substrate and adjacent to the negative-index layer 126. The embedding may occur while the photoresist 114 is wet to facilitate immersion of the nanoparticles in the surface of the photoresist 114, and the photoresist 114 is chosen to be sufficiently thin to meet the needs of a particular application.

In this alternative implementation, the photoresist 114 may be a thermal photoresist that does not first require curing via the additional first wavelength of electromagnetic energy 128. Such a photoresist 114 may be made by selectively mixing a standard commercially available cross-linking agent, such as Lewis acid or photoacid, with a conventional negative photoresist, such as SU-8. The exact cross-linking agents are application specific and may be readily chosen by those skilled in the art with access to the present teachings to meet the needs of a given application. When the desired cross-linking agent is mixed with or diffused into the photoresist 114, such as SU-8, the cross-linking agent assists and accelerates cross-linking of the photoresist 114 upon heating after exposure to the electromagnetic energy 130.

The second wavelength of electromagnetic energy 130 is chosen to both resonate with the nanoparticles 116 and to work with the superlens 124, 126 such that surface plasmon resonance occurs at the surface of the negative-index material 126 closest to the nanoparticles 116. In addition, the chosen wavelength (λ2) acts to simultaneously activate the photoresist so that heating of the nanoparticles 116 causes the photoresist surrounding the heated nanoparticles 134 to harden in the activation areas 136. Hence, instead of exposing the photoresist 114 to electromagnetic energy twice, i.e., with two different wavelengths (λ1 and λ2) of electromagnetic energy, the photoresist 114 is exposed once to the electromagnetic energy 130. The resonant wavelengths of the nanoparticles 116 and the operating wavelength of the superlens 124, 126 are designed to be similar wavelengths. Consequently, photoresist activation (sometimes called ‘baking’) occurs during the exposure to the electromagnetic energy 130. This may enable generation of smaller sub-wavelength features that would be obtained with a blanket post exposure bake.

Furthermore, in this alternative implementation, the pattern of the mask 132 may be transferred to another substrate (not shown) without the need to develop the resulting photoresist pattern on the top of the negative-index material 126.

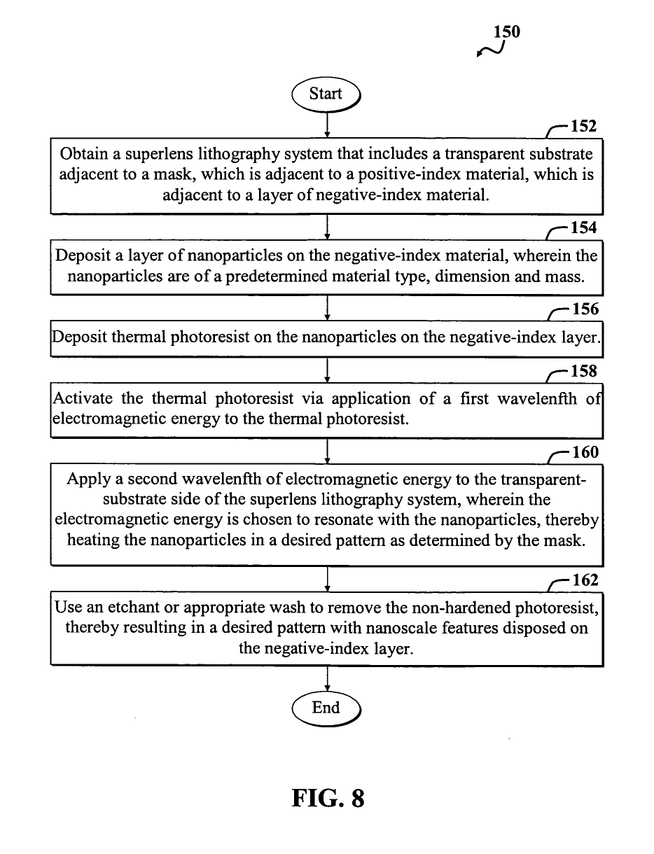

FIG. 8 is a flow diagram of a method 150 adapted for use with the thermal nanolithography system illustrated in FIG. 7. A first step 152 of the method 150 includes obtaining a superlens lithography system that includes a transparent substrate adjacent to a mask, which is adjacent to a positive-index material, which is adjacent to a layer of negative-index material.

A second step 154 includes depositing a layer of nanoparticles on the negative-index material, wherein the nanoparticles are of a predetermined material type, dimension and mass.

A third step 156 includes depositing thermal photoresist on the nanoparticles on the negative-index layer.

In a fourth step 158, the thermal photoresist is then activated via application of a first wavelength of electromagnetic energy to the thermal photoresist.

A fifth step 160 includes applying a predetermined second wavelength of electromagnetic energy to the transparent-substrate side of the superlens lithography system. The second wavelength of electromagnetic energy is chosen to resonate with the nanoparticles, thereby heating the nanoparticles in a predetermined pattern as determined by the mask. This hardens the resulting heated photoresist in a so-called activation region about the heated nanoparticles.

A sixth step 162 includes using an etchant or appropriate wash to remove the non-hardened photoresist, thereby resulting in a desired pattern with nanoscale features disposed on the negative-index layer.

Note that various steps 152-162 of the method 150 may be altered, rearranged, or omitted without departing from the scope of the present teachings. For example, the fourth step 158 may be omitted in cases where the thermal photoresist does not require activation via electromagnetic energy.

While various embodiments have been discussed herein with respect to superlenses using thin metallic layers, embodiments of the present invention are not limited thereto. For example, metamaterials may be employed to implement superlenses at higher frequencies, such as X-ray frequencies, and may be used with immersion lithography techniques discussed herein without departing from the scope of the present teachings. Furthermore, while various embodiments have been discussed with respect to use for nanolithography, embodiments are not limited thereto. For example, certain embodiments discussed herein may be used to create features that are larger than nanoscale features, without departing from the scope of the present invention.

Exact materials and dimensions of various components employed to implement embodiments discussed herein are application specific. Those skilled in the art with access to the present teachings may readily employ desired materials to meet the needs of a given application.

Although the invention has been discussed with respect to specific embodiments thereof, these embodiments are merely illustrative, and not restrictive, of the invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances, some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

What is claimed is:

1. An imaging device comprising:
a positive-index material;
a negative-index material adjacent to the positive-index material, wherein the negative-index material; and
a thermal resist positioned on a side of said negative-index material opposite said positive-index material.

2. The imaging device of claim 1 wherein the thermal resist includes one or more nanoparticles positioned therein, thereon, or adjacent thereto.

3. The imaging device of claim 2 wherein the one or more nanoparticles are adapted to be heated by electromagnetic energy emanating from said negative-index material.

4. The imaging device of claim 1 further including a substrate adjacent to a side of said positive-index material opposite said negative index material.

5. The imaging device of claim 4 further including a mask extending into said positive-index material and adjacent to said negative-index material.

6. The imaging device of claim 1 wherein the thermal resist is directly adjacent to the negative-index material and lacks an immersion layer therebetween.

7. The imaging device of claim 1 wherein the negative-index material includes aluminum.

8. The imaging device of claim 1, wherein the positive-index material includes a dielectric layer less than 50 nanometers thick.

9. The imaging device of claim 1, wherein the dielectric layer includes Poly(Methyl MethAcrylate).

10. The imaging device of claim 9, wherein the negative-index material includes a smoothed aluminum layer less than 50 nanometers thick, and wherein the aluminum layer is disposed on the dielectric layer or vice versa, forming a superlens comprising the aluminum layer and the dielectric layer.

11. The imaging device of claim 10, further including plural aluminum layers separated by one or more layers of positive-index material.

12. The imaging device of claim 11 wherein the one or more layers of positive-index material include plural layers of positive-index material characterized by selectively different refractive indices.

13. The imaging device of claim 9, further including a mask adjacent to the positive-index material.

14. The imaging device of claim 13, further including a substantially transparent layer into which one or more features of the mask extend.

15. The imaging device of claim 13, wherein the mask is disposed on or in the dielectric layer so that the positive-index material separates the mask from the smoothed aluminum layer.

16. The imaging device of claim 13, further including a space between the thermal resist, which is thermal photoresist, and the negative-index material.

17. The imaging device of claim 16, wherein the space is less than 50 nanometers across as measured perpendicularly from the photosensitive material to the negative-index material.

18. The imaging device of claim 16, wherein the space is filled with an immersion material with a refractive index with a real part greater than 1.

19. The imaging device of claim 13, further including a source of electromagnetic energy positioned to enable transmission of the electromagnetic energy toward a side of the superlens closest to the positive-index material.

20. The imaging device of claim 19, wherein the source of electromagnetic energy is adapted to produce electromagnetic energy with a center frequency corresponding to a wavelength of approximately 193 nanometers.

21. An imaging device comprising:
a positive-index material;
a negative-index material adjacent to the positive-index material;
a photosensitive material;
an immersion material separating the negative-index material and the photosensitive material; and
an illumination source adapted to produce an interference pattern of electromagnetic energy, wherein the illumination source is positioned to cause said interference pattern to impinge on a surface of the positive-index material opposite the negative-index material

22. The imaging device of claim 21 wherein the photosensitive layer is thermally sensitive and includes one or more nanoparticles in contact therewith.

23. The imaging device of claim 21, further including a mask disposed on, in, or adjacent to the positive-index material and positioned so that at least some of the positive-index material separates the mask from the negative-index material.

24. An imaging device comprising:
plural layers of negative-index material and
plural layers of positive-index material separating the plural layers of negative-index material, wherein each of the plural layers of positive-index material are characterized by selectively different refractive indices.

25. The imaging device of claim 24, wherein the plural layers of positive-index material include a first layer of positive-index material and a second layer of positive-index material, wherein a real part of a refractive index of the second positive-index layer is larger than the real part of a real part of a refractive index of the first positive-index layer.

26. The imaging device of claim 24, further including a photosensitive layer adjacent to one of the plural layers of negative-index material.

27. The imaging device of claim 26, further including a beam of electromagnetic energy incident on a mask that is positioned on, in, or adjacent to one of the one or more layers of positive-index material.

28. The imaging device of claim 27 wherein the photosensitive layer includes thermal photoresist with one or more nanoparticles in contact therewith, wherein the nanoparticles are adapted to resonate with a electromagnetic energy of said beam of electromagnetic energy.

29. A method for manufacturing an imaging device, the method comprising:
determining a desired pattern to create in photosensitive material
selecting a wavelength of electromagnetic energy to which the photosensitive material is sensitive,
creating a mask based on the desired pattern;
forming a first layer of positive-index material, wherein the mask is positioned on, in, or in proximity to the first layer of positive-index material;
forming a second layer of negative-index material on the first layer, wherein the second layer is characterized by a thickness and material type according to the wavelength and dimensions of the desired pattern; and
positioning a photosensitive material adjacent to said negative-index material.

30. The method of claim 29, wherein the photosensitive material is in contact with or includes one or more nanoparticles that are adapted to resonate with the selected wavelength of electromagnetic energy.

31. The method of claim 29, wherein the first layer is characterized by a first thickness and material type according to the wavelength and dimensions of the desired pattern, and wherein the second layer is characterized a second thickness and material type according to the wavelength and dimensions of the desired pattern.

32. The method of claim 31, wherein forming the first layer includes depositing the first layer on the mask on the substantially transparent substrate, and wherein forming the second layer includes depositing the second layer on the first layer.

32. A method comprising:
obtaining an imaging device that includes a mask separated from a negative-index material via a positive-index material;
positioning the imaging device so that a side of the imaging device closest to the negative-index material is sufficiently close to a photosensitive layer to enable a pattern of evanescent waves to emanate from the mask to reach and selectively alter the photosensitive layer, and wherein the negative-index material is adjacent to the photosensitive layer; and
applying electromagnetic energy of a predetermined wavelength to a side of the imaging device closest to the mask, thereby altering the photosensitive layer in accordance with the pattern representative of a pattern characterized by the mask.

33. The method of claim 32, wherein the imaging device includes a superlens lithography system that further includes plural layers of negative-index material separated by dielectric materials with different indices of refraction.
